(19) United States
(12) Patent Application Publication
(10) Pub. No.: US 2008/0209940 A1
(43) Pub. Date: Sep. 4, 2008

(54) Gust Water Trap Apparatus

(75) Inventor: Maxwell Edmund Whisson, Subiaco (AU)

Correspondence Address: BACHMAN & LAPOINTE, P.C., 900 CHAPEL STREET, SUITE 1201, NEW HAVEN, CT, 06510, US

(73) Assignee: WATER UN LIMITED, West Perth, WA (AU)

(21) Appl. No.: 11/996,347

(22) PCT Filed: Jul. 20, 2006
(86) PCT No.: PCT/AU2006/001023

§ 371 Date: Jan. 25, 2008

(30) Foreign Application Priority Data
Jul. 22, 2005 (AU) 2005903901

(51) Int. Cl. E03B 3/28; B01D 5/00

(52) U.S. Cl. 62/467

(57) ABSTRACT

A Gust Water Trap Apparatus comprises means (9, 42, 52) for receiving air from ambient wind and means for feeding the received air into a compression chamber (46, 56). Restriction means (21, 41) leads from the compression chamber into a condensation chamber (18). The apparatus leads to an increase in the pressure of air from wind gusts so that the air loses energy and is cooled further in the condensation chamber so as to deposit liquid water in the condensation chamber.

### FIELD OF THE INVENTION

The present invention relates to a Gust Water Trap Apparatus.

### BACKGROUND OF THE INVENTION

The present invention seeks to take advantage of the fact that wind pressure varies greatly and short term gusts often have power in excess of average wind power. Thus air trapped in such a way as to have increased pressure will have an increase in temperature leading to loss of energy so encouraging condensation of water from the air.

### SUMMARY OF THE INVENTION

In accordance with one aspect of the present invention there is provided a Gust Water Trap Apparatus characterised by comprising a means for receiving air from ambient wind, means for feeding the received air from ambient wind into a compression chamber, restriction means leading from the compression chamber into a condensation chamber, such that, as air passes from the compression chamber to the condensation chamber it is cooled so as to deposit liquid water in the condensation chamber.

### BRIEF DESCRIPTION OF THE DRAWINGS

The present invention will now be described, by way of example, with reference to the accompanying drawings in which:—

FIG. 1 shows a schematic horizontal section of a first embodiment of a Gust Water Trap Apparatus in accordance with the present invention;

FIG. 2 shows a schematic vertical longitudinal section of a second embodiment of a Gust Water Trap Apparatus in accordance with the present invention;

FIG. 3 shows a vertical longitudinal section view of a third embodiment of a Gust Water Trap Apparatus in accordance with the present invention;

FIGS. 4, 5 and 6 show various views of a fourth embodiment of a Gust Water Trap Apparatus in accordance with the present invention;

FIG. 7 shows a vertical longitudinal section of a fifth embodiment of a Gust Water Trap Apparatus in accordance with the present invention;

FIG. 8 shows a vertical longitudinal section of a sixth embodiment of a Gust Water Trap Apparatus in accordance with the present invention;

FIGS. 9, 9a and 10 show various views of a seventh embodiment of a Gust Water Trap Apparatus in accordance with the present invention;

FIG. 11 shows a vertical section of an eighth embodiment of a Gust Water Trap Apparatus in accordance with the present invention;

FIG. 12 shows a vertical section of ninth embodiment of a Gust Water Trap Apparatus in accordance with the present invention; and

FIG. 13 shows a vertical section of a tenth embodiment of a Gust Water Trap Apparatus in accordance with the present invention.

### DESCRIPTION OF THE INVENTION

In the following description like reference numerals are used to denote like parts in the various embodiments of the present invention.

In one preferred embodiment of a Gust Water Trap Apparatus in accordance with the present invention a wall perforated by openings is kept approximately perpendicular to the wind by a suitable wind monitor such as a wind vane or anemometer arranged to control the orientation of the device, which may be mounted on a vertical axis or on wheels running on a circular track.

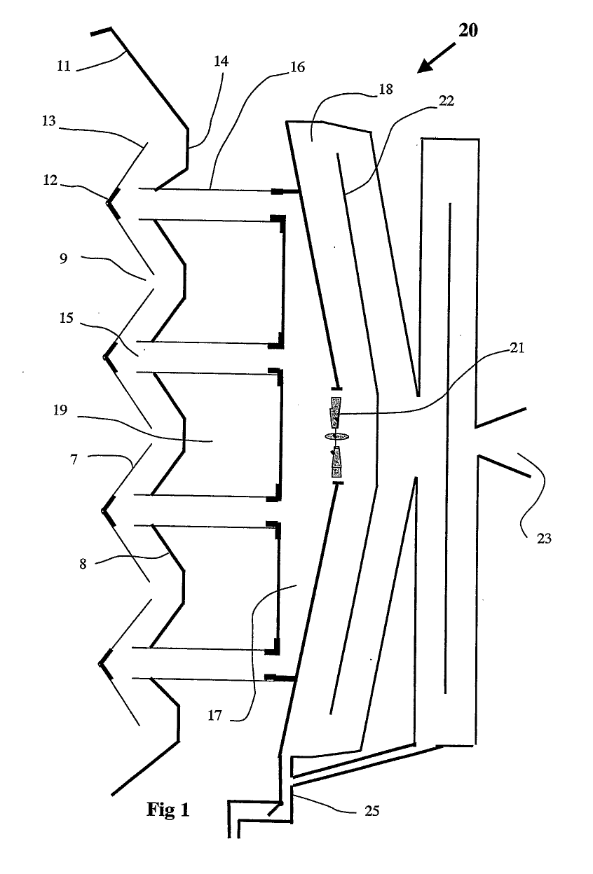

One such embodiment 20 is illustrated in FIG. 1 in which a wind-intercepting structure comprises a front wall 7 having upright slots 9 with angled wind-guiding flaps 13 disposed adjacent to the slots 9. The flaps 13 are mounted on strong rods or girders 12 such that incident wind is directed through the slots 9 after which the wind impacts against an irregular rear wall 14. The rear wall 14 approximately follows the course of the front wall 7 and has solid wall portions opposite the slots 9. Thus, the wind is directed laterally and back toward the incoming wind direction by the irregular wall 14. Opposite the girders 12 the wall 14 is interrupted by ducts 16 which extend rearwardly to a compression chamber 17. The incoming wind escapes into the ducts 16 and then into the chamber 17.

Escape from the chamber 17 is restricted, the restriction to flow in this embodiment taking the form of a wind turbine 21 through which wind may escape into a condensation chamber 18 and then out to the ambient air through an exit 23. The path length of the air moving through the condensation chamber 18 is increased by baffles 22 located in the chamber 18. The walls of the condensation chamber 18 are typically constructed with a large surface area of material which is a good heat conductor.

In use, wind is intercepted over a large area, maximised where practicable by angled sheets shown as 11 in FIG. 1. Wind turbines which may be used for the generation of power may be fitted on the top and sides of the wind intercepting face of the Gust Water Trap Apparatus 20 if desired. The wind-guiding flaps 13 are preferably somewhat flexible so that the openings 9 become wider when wind strength increases but almost close when wind strength drops to low levels. In this way air is trapped in the ducts 16 and the chamber 17 at increased pressure due to storage of the momentum of the incoming wind with exit from the chamber 17 restricted by the resistance to flow offered by the turbine 21. The ducts 16 are preferably arranged to have a high surface area and have walls of good thermally conducting material such as aluminium sheet which are exposed to ambient air circulating in adjacent spaces 19. The spaces 19 are disposed between the ducts 16 and are preferably exposed to the open air as freely as practicable.

The condensation chamber 18 may with advantage be fitted with one or more heat pumps or refrigeration coils to remove heat. Such devices may be powered by wind turbines or by photovoltaic panels or other means of collecting solar energy which may conveniently be mounted on an upper surface of the apparatus of the present invention.

In operation, the momentum of gusts of wind results in a small rise of temperature in the ducts 16. Heat is therefore lost through walls of the ducts 16. A drop in pressure as air passes through the turbine 21 results in a fall in temperature so encouraging condensation of water which drains down to a collecting pipe 25.

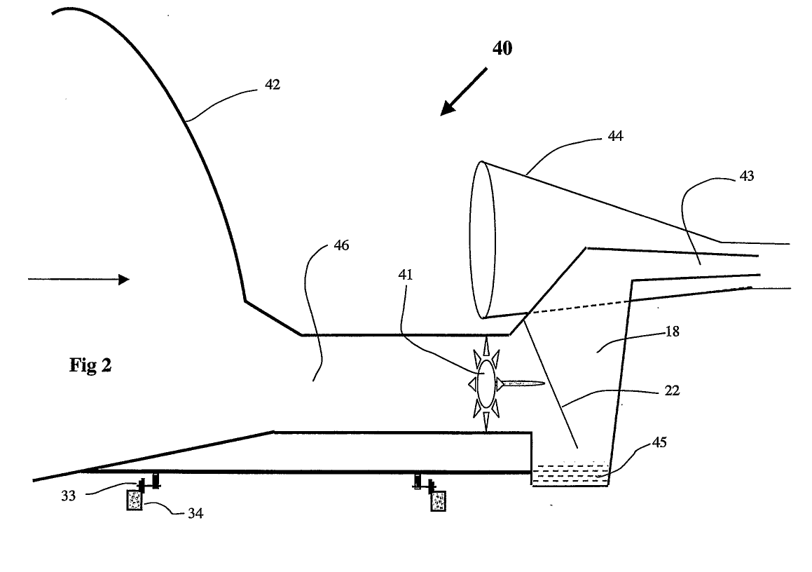

An alternative preferred form of the Gust Water Trap Apparatus 40 of the present invention is shown in FIG. 2 wherein wind is collected in a large funnel 42. The funnel 42 in FIG. 2 may have a circular, oval or oblate section at an opening thereof tapering down to open into a compression chamber 46. The chamber 46 opens through a resistance, here shown as a wind turbine 41, into a condensation chamber 18 which preferably has baffles 22 to produce a longer flow path to an air exit 43. In the embodiment illustrated in FIG. 2 the air exit 43 from the condensation chamber 18 leads into a Venturi tube through which air collected by an auxiliary funnel 44 flows at high velocity. The function of this arrangement is to lower the pressure in the condensation chamber 18. The compression chamber 46 preferably comprises several tubes constructed of a good thermal conductor material with a large surface area. Similarly, the condensation chamber 18 preferably has a large surface area so that heat of condensation is rapidly lost through the walls. A refrigeration or heat pump unit may with advantage cool part of the walls of the condensation chamber 18 and such a unit is preferably powered by a wind turbine. Water condensing in the condensation chamber 18 is able to drain into a collecting container 45. The whole device is shown mounted on wheels 33 running on a circular track 34 but a vertical axis mount may be used instead. Orientation so that the funnel 42 captures the maximum amount of wind is preferably by a drive responsive to wind direction as detected, for example, by a small wind vane. However, in some applications the shape of the compression chamber 46 and the condensation chamber 18 may be arranged to present a large vertical face to the wind when the device is not correctly aligned so that these vertical faces restore correct orientation after the fashion of a wind vane.

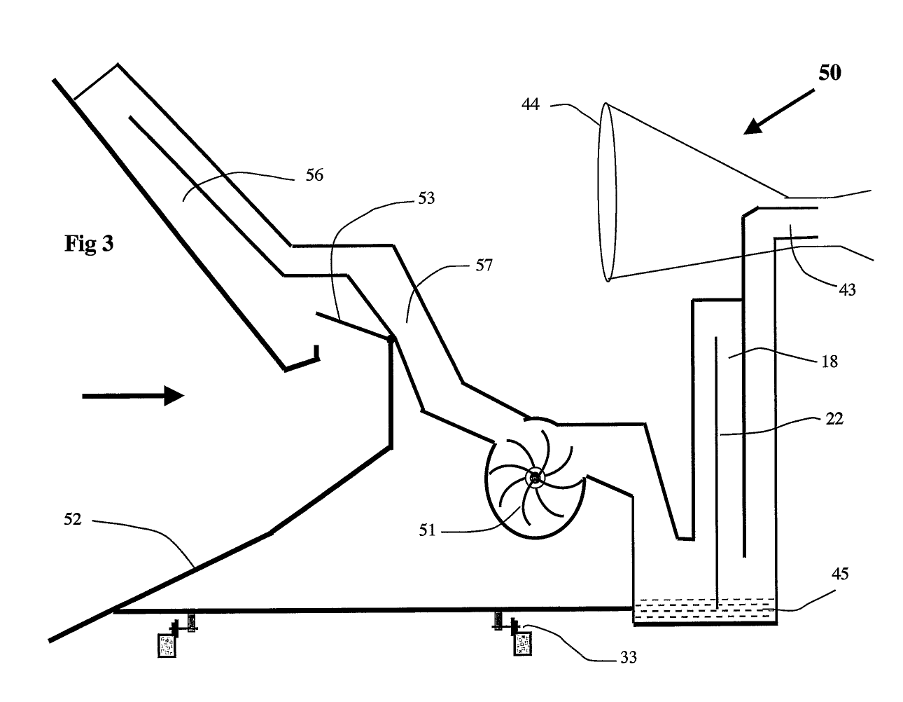

A slightly different arrangement of Gust Water Trap Apparatus 50, in accordance with the present invention is shown in FIG. 3. The main features of the Apparatus 50 are that the wind entering a funnel 52 is diverted back through a flap 53 into a compression chamber 56 which is built on an outer surface of the funnel 52. The flap 53 is arranged to be readily opened by wind gusts but falls shut when wind speed falls or when the pressure in the compression chamber 56 is high. The path length of air passing through the compression chamber 56 is increased by internal baffles and the surface area is made as large as practicable to maximise the rate of heat loss to the environment. The outer surface of the compression chamber 56 is preferably shaded to prevent heating by solar radiation.

An extension 57 of the compression chamber 56 directs air over a turbine 51 which offers resistance to the flow of air into a condensation chamber 18. The power output of the turbine 51 may be directly coupled to a compressor of a refrigeration system or heat pump which is preferably arranged to cool a wall or baffle 22 of the condensation chamber 18. The surfaces of the walls of the condensation chamber 18 and the baffle 22 are preferably formed of a material which encourages vapour droplets to adhere and coalesce so that they will descend to a collection channel 45. Suitable materials and surface coatings include nylon mesh and various hydrophobic sprays and paints designed to produce a surface which causes water droplets to have a large contact angle with the surface.

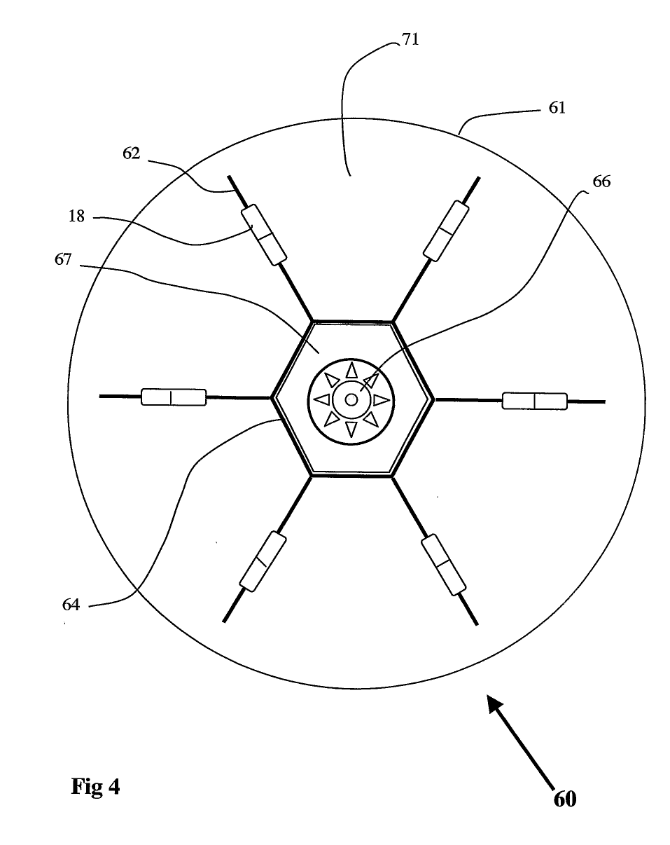

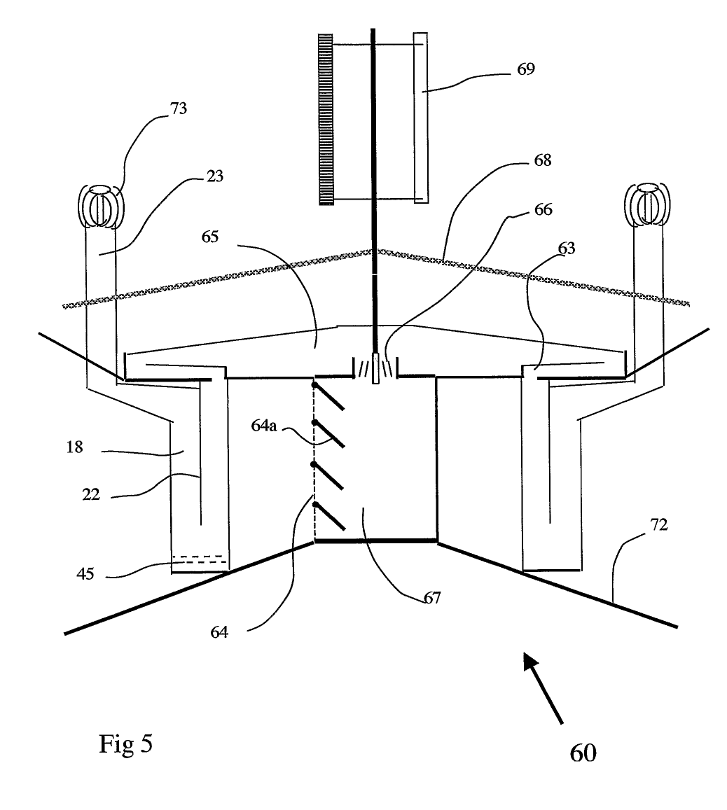

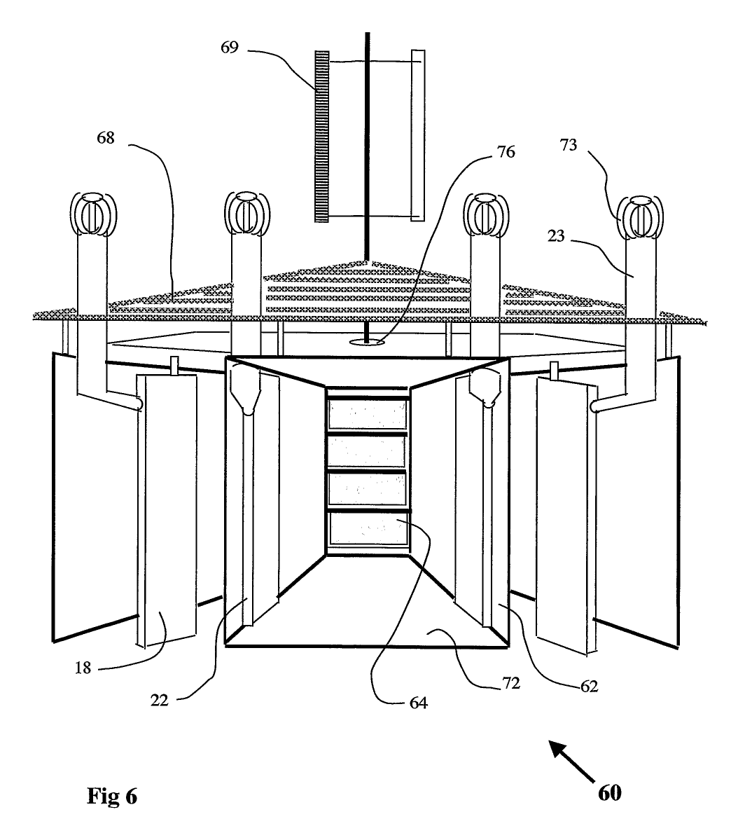

In a further preferred embodiment 60 of the Gust Water Trap Apparatus of the present invention the structure has multiple funnel shaped openings so that rotation to face into the wind is unnecessary. A particularly preferred arrangement of this kind is shown in FIGS. 4, 5, and 6. As in all embodiments of the Gust Water Trap Apparatus of the present invention the efficiency of collection of water from the air can be increased by siting the device close to a water surface, for example, by mounting the device on a small island, float or platform in a salt water lake. The arrangement shown in FIGS. 4, 5 and 6 may be particularly well suited to this kind of location. It is also very suitable for other sites however and is conveniently mounted on a sand dune or hill top inland. In FIG. 4 a horizontal section is represented and it can be seen that the device has an approximately circular base 61 and a set of 6 upright radial walls 62 which offer openings 71 to approaching wind. In FIG. 5 vertical sections of two of the condensation chambers 18 are shown and a funnel structure is completed by a floor 72 and a ceiling. These surfaces together with the radial walls 62 form a funnel which directs incoming air to a central chamber 67. Walls 64 of the central chamber 67 incorporate hinged flaps 64a which can be easily opened by incoming wind but close under the influence of gravity when wind pressure falls. In FIG. 5 as shown wind is blowing into the left side funnel and opening the flaps 64a in the wall 64 at the end of the funnel. On the right, the funnel is open downwind so that no wind enters and the flaps 64a in the wall 64 are closed with the result that air is trapped in the central chamber 67. A fan 66, here shown directly powered by a vertical axis wind turbine 69, compresses the incoming air into a compression chamber 65 from which it can exit into any or all of the condensation chambers 18 through a high resistance opening 63. The condensation chamber 18 has a large surface area made of thermally conducting sheet such as aluminium and is shaded by a roof 68. The exit of air from the condensation chamber 18 is accelerated by a suitable Venturi or fan arrangement and in the accompanying drawings this is shown in the form of wind-driven extractor fans 73 fitted to outlets of vents 23. These arrangements are further illustrated in FIG. 6 which represents a view from a direction of wind entering one of six funnels but in this figure flaps 64a in the wall 64 are only slightly open as would be the situation with a very light wind.

In operation, strong wind gusts enter the central chamber 67, the air is compressed in the compression chamber 65 and any rise in temperature associated with compression results in dissipation of heat through upper and lower surfaces of the compression chamber 65. The air pressure falls as air flows through the restriction 63 so that condensation of water contained in the air is encouraged. If preferred a wind turbine, photovoltaic panels or other sources of power may be used to power a heat pump to further cool portions of the condensation chambers 18. If preferred the dissipation of heat to the ambient air can be accelerated by incorporating fluid channels in the walls of the chambers. These sealed channels could, for example, contain water arranged to carry heat to an external surface by convection.

To conserve power a simple logic program and suitable wind humidity and temperature sensors and timers may be installed so that heat pumps or refrigeration compressors will operate preferentially at times when these devices will have the greatest effect in causing condensation resulting in the maximum recovery of water at 45 for the minimum expenditure of energy. The various air flows and pressures are ideally optimised by suitable computer models and it may be preferable in some conditions for the wind-driven output power of the fan 66 to be sufficiently high to allow flaps 64a in the downwind walls 64 to open and allow some entry of air into the central chamber 67 in addition to the main air entry through the upwind wall 64.

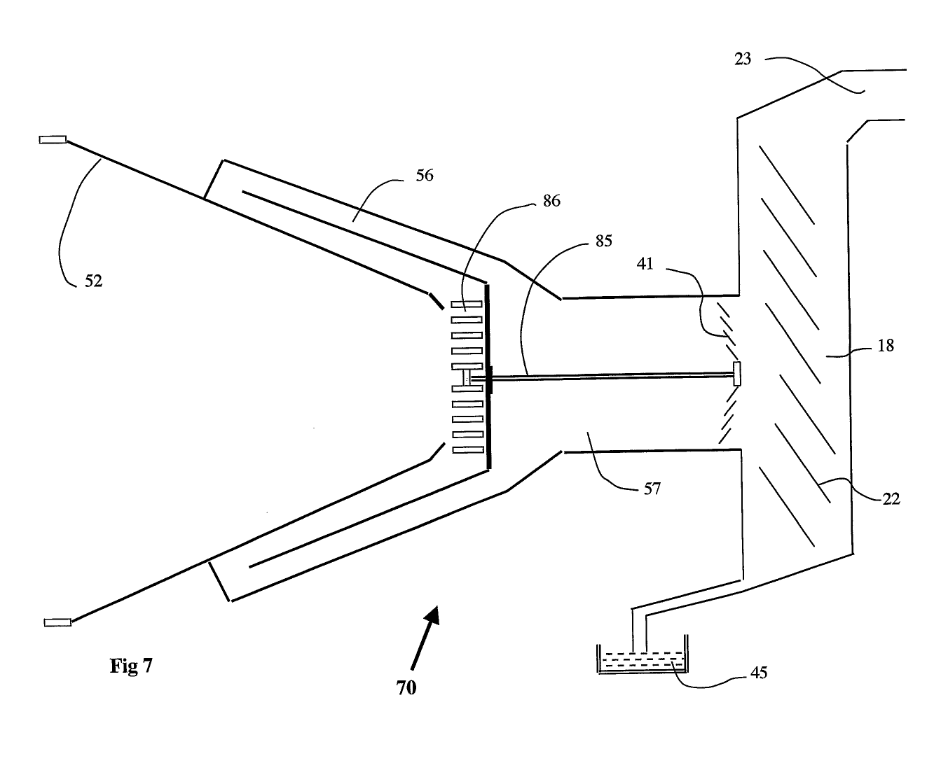

In a further preferred embodiment a turbine restricting flow from a compression chamber into a condensation chamber drives or assists in driving a compressor which adds to the pressure of a gust of air captured by a funnel and flowing into a compression chamber. Such an arrangement is shown in FIG. 7 which shows a vertical section of a preferred embodiment of a Gust Water Trap Apparatus 70 in accordance with the present invention. A funnel 52 may have any preferred transverse sectional shape such as oval or oblate and the opening is preferably as large as practicable. The opening and the whole device is oriented to face oncoming wind either by a powered drive system or by arranging the aerodynamic shape of the whole device so that it feathers into the wind. If preferred a drive system may be a simple coupling of a wind turbine 41 with an axis transverse to the main axis of the system so that it generates power when wind is blowing at an angle to the main axis, the direction of rotation of the turbine then acting by direct coupling to restore alignment of the device into the wind.

A centrifugal fan 86 is mounted at a narrow downwind end of a funnel 52 such that rotation of the fan accelerates the flow of air captured by the funnel 52 into a compression chamber 56, from which air may flow through a duct 57, through a power wind turbine 41 and into a condensation chamber 18. The wind turbine 41 may simply be connected by a shaft 85 mounted on suitable bearings to the fan 86. The energy to drive the fan 86 is partly from the direct action of wind gusts on angled blades of the fan 86 and partly from the action of air compressed in the duct 57 passing through the wind turbine 41. The nett effect of these forces is to increase the pressure in the chamber 56 and the duct 57. This chamber and duct are arranged to have a large surface area and walls of high thermal conductivity, so that any rise in temperature due to compression of air within them results in loss of heat to the outside ambient air. Passage of air through the turbine 41 results in a fall in pressure as the air enters the condensation chamber 18 so that the temperature of the air falls so encouraging condensation on walls of the condensation chamber 18 and on baffles 22 so that water drains into a collection channel 45. Air then leaves the condensation chamber 18 through a vent 23 which may have a wind driven exhaust fan or Venturi arrangement if desired to further reduce the pressure in the condensation chamber 18 when wind is blowing. If desired the power of the fan 86 may be augmented, for example, by an electric motor coupled to the shaft 85 and powered by a separate wind turbine or a photovoltaic solar panel or wind turbine.

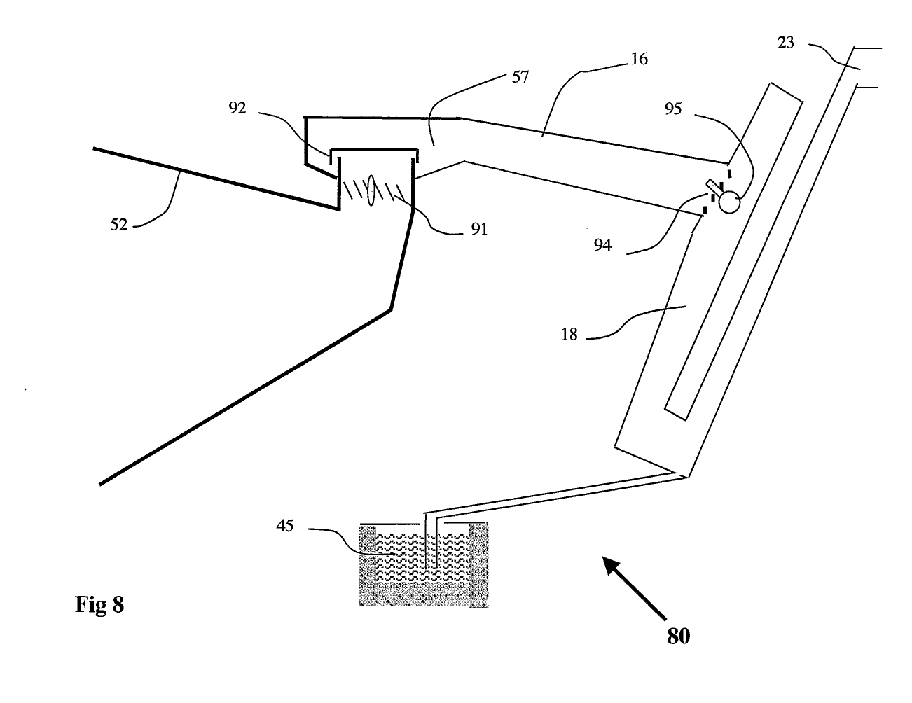

A similar arrangement is represented in FIG. 8, which shows a Gust Water Trap Apparatus 80 in vertical longitudinal section with the funnel 52 opening into the wind and a fan 91 acting to increase pressure of air captured in a compression chamber 57. In this preferred embodiment the fan 91 is driven by electric power and the combined action of the fan 91 and the force of incoming gusts of wind acts to lift a cover 92 so allowing air to enter the compression chamber 57. When the pressure in the compression chamber 57 is high in comparison to the combined pressure generated by incoming wind and the power of the compressor fan 91, the cover 92 falls shut preventing retrograde escape of the trapped air. Air in the compression chamber 57 may flow through a duct 16 and then through a wind turbine 94 into a condensation chamber 18 and then out through a vent 23. The wind turbine 94 is preferably coupled to an alternator 95 to generate electricity which can if preferred contribute to the power of the compressor fan 91. If preferred the wind turbine 94 may be coupled directly to the compressor unit of a refrigeration unit, the evaporation coil of which can conveniently be fitted to parts of the walls of condensation chamber 18 to increase the rate of condensation of water from the air passing through the system. As with the other embodiments of the present invention computer modelling is desirable to optimise the performance of the systems and in the Gust Water Trap Apparatus 80 it may be advantageous to augment the power of the compressor fan 91 when the relative humidity of incoming air is high.

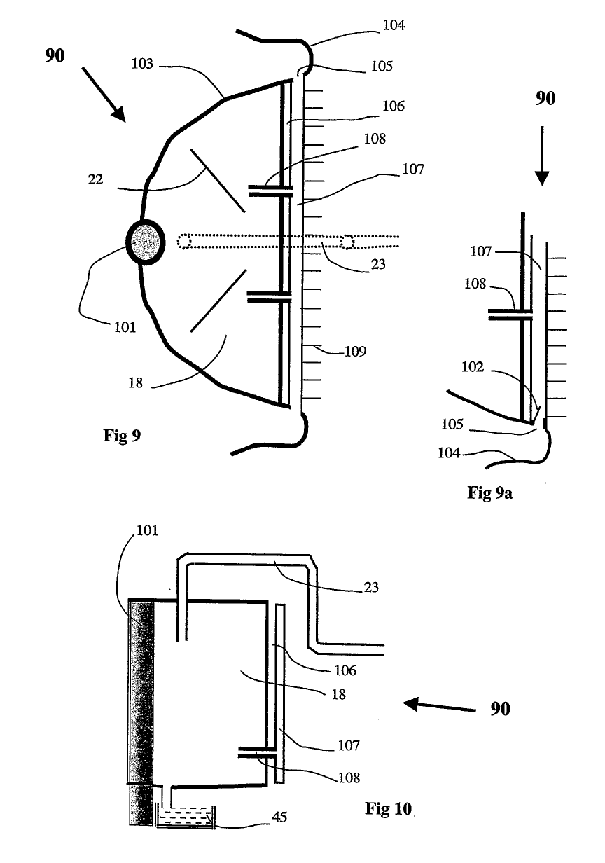

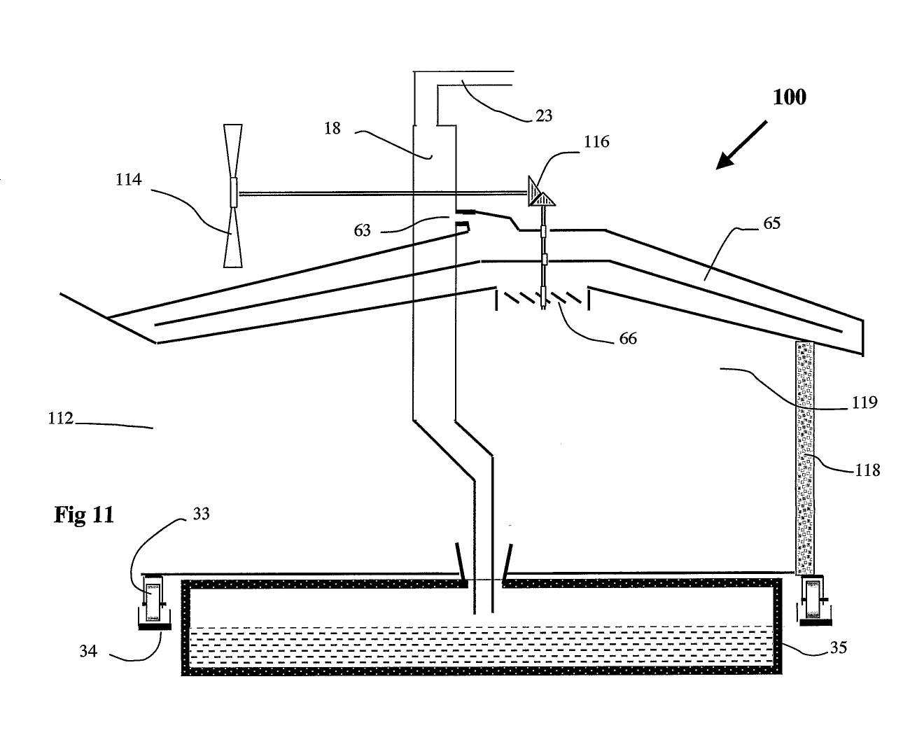

A different system of trapping wind is represented by a Gust Water Trap Apparatus 90 shown in FIGS. 9, 9a and 10. This embodiment of the present invention is distinguished by an arrangement for directing wind into a compression chamber 107. The system is shown mounted on a pole 101 around which it can rotate so that the pole 101 is always upwind in relation to the system. A convex wall 103 shown in horizontal section in FIG. 9 forms a front wall of a condensation chamber 18 and acts to divert incident wind laterally so that the wind is intercepted by lateral funnels 104. The intercepted wind can escape through a slot 105 into a flat compression chamber 107 mounted just behind a compression chamber 18 separated by a ventilation space 106. The ventilation space 106 is open to the ambient air at least at the top and bottom thereof of the apparatus as shown in vertical section in FIG. 10. The compression chamber 107 is formed of sheets of high thermal conductivity to facilitate loss of heat of compression and fins 109 are shown fitted to an outside rear wall to assist heat dissipation. Air passing into the compression chamber 107 may pass into the condensation chamber 18 through one or more tubes 108. The high resistance to flow through the tubes 108 ensures that the pressure in the condensation chamber 18 is lower than the pressure in compression chamber 107. Air may exit from the condensation chamber 18 through a vent 23 (see FIG. 10) and the flow of air through the vent 23 may be accelerated if preferred by a suitable exhaust turbine or Venturi. Baffles 22 are preferably formed of mesh which favours the coalescence of water droplets on their surface and the temperature of the baffles 22 is preferably kept low either by thermal contact with the outside walls of the condensation chamber 18 or by a heat pump or a phase change refrigeration coil. If preferred a heat pump or refrigeration system may be powered by an external wind turbine or by wind turbines mounted in the tubes 108. A further preferred refinement is the incorporation of a non-return gust flap 102 fitted at an opening of the lateral funnels 104 into the compression chamber 107. The flap 102 is arranged to be easily opened by a wind gust entering the lateral funnel 104 and to close when the pressure on the flap exerted by the air in the compression chamber 107 exceeds the pressure on the outside wall of flap 102 caused by incoming wind. Water condensing on walls and baffles of the condensation chamber 18 collects in a collection chamber 45.

A further alternative is the Gust Water Trap Apparatus 100 is shown as a vertical section in FIG. 11. This form of the apparatus of the present invention is similar to Gust Water Trap Apparatus 60 shown in FIGS. 4, 5 and 6 but in this embodiment there is only one opening 112 to capture wind gusts and only one chamber 119 into which wind initially flows. The opening 112 occupies a large proportion, perhaps one third, of the periphery of a polygonal or approximately circular structure mounted on wheels 33 mounted on a circular track 34 disposed above a water collecting reservoir 35. A solid wall 118 occupies most of the periphery, perhaps two thirds, of the chamber 119 and supports a roof (not shown) similar to the roof 68 in FIG. 5. The wall 118 also supports a compression chamber 65. Wind entering the chamber 119 from the opening 112 can be compressed by a fan 66 driven in this example by a wind turbine 114 through a drive train 116. The compression chamber 65 has a large surface area and internal baffles which increase the path length of compressed air allowing it to cool to ambient temperature. If desired heat pumps or refrigeration systems powered by wind turbines or solar photovoltaic panels or other sources of power may further lower the temperature of the air passing through the compression chamber 65. Air may escape from the compression chamber 65 through a restricted opening 63 leading into a condensation chamber 18. The function of the condensation chamber 18 is similar to that described in the other embodiments of the present invention.

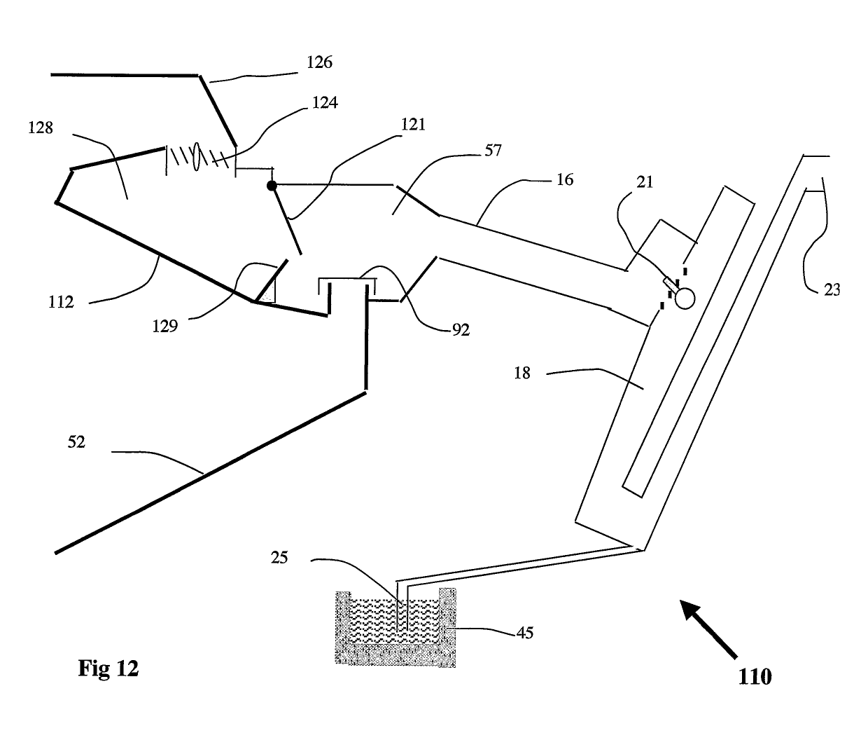

A further preferred embodiment of the invention is shown in vertical section as a Gust Water Trap Apparatus 110 in FIG. 12. This embodiment is characterised by a second funnel 126 leading to a powered compressor fan 124 which is preferably programmed to maintain a selected increased pressure in an auxiliary compression chamber 128. Wind gusts entering a main funnel 52 act to lift a cap 92 allowing air to flow into compression chamber 57. If the pressure generated by the gust exceeds the pressure generated by the compressor fan 124 acting on wind collected by the auxiliary funnel 126 then a flap 121 shuts against a stop 129 and air exits through a turbine 21 into a condensation chamber 18 and then through a vent 23. With the weakening of the wind gust the cap 92 falls shut under the influence of gravity and the flap 121 is opened by the combined action of the air entering the funnel 126 and the action of the compressor fan 124. As in previous embodiments the device is oriented so that the funnels 52 and 126 are open toward the oncoming wind, the whole device being mounted either on a vertical axis or on wheels on a circular track. The compressor fan 124 may be powered by the output of an electricity generator driven by the turbine 21 and/or by other sources of power such as an external wind turbine or photovoltaic panels.

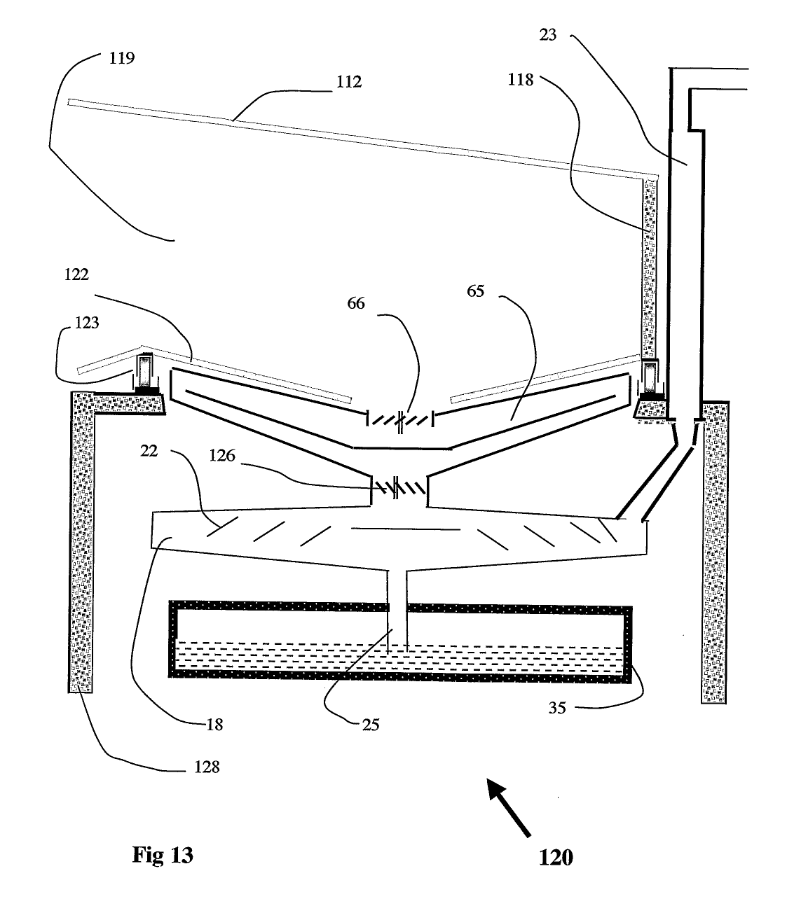

An alternative embodiment of the Gust Water Trap Apparatus 120 of the present invention is shown in vertical section in FIG. 13 and it can be seen that most of the components are mounted on a fixed foundation and only a wind capturing funnel, mounted on a circular track 123, can rotate so that the opening is brought by appropriate monitors and drive systems to face into the wind. The wind-capturing funnel has a roof 112, a wall 118 partially enclosing a chamber 119 but having an opening occupying approximately one third of the periphery of the chamber 119 so allowing free entry of incident wind. A compressor fan 66 is mounted through a floor of the chamber 119. A drive for the compressor fan 66 is not shown but it may be powered by electricity or wind or other energy source as preferred. The vertical axis of the compressor fan 66 is preferably aligned with the axis of rotation of the wind capturing chamber 119. A compression chamber 65 disposed below the chamber 119 leads through a resistance, which preferably takes the form of a wind turbine 126, to a condensation chamber 18 opening to an air vent 23.

Modifications and variations such as would be apparent to a skilled addressee are deemed within the scope of the present invention.

1. A Gust Water Trap Apparatus characterised by comprising a means for receiving air from ambient wind, means for feeding the received air from ambient wind into a compression chamber, restriction means leading from the compression chamber into a condensation chamber, such that, as air passes from the compression chamber to the condensation chamber it is cooled so as to deposit liquid water in the condensation chamber.

2. A Gust Water Trap Apparatus according to claim 1, characterised in that the means for receiving air from ambient wind comprises an entry having a funnel leading into the compression chamber.

3. A Gust Water Trap Apparatus according to claim 2, characterised in that a wind turbine is located in the compression chamber remote from the funnel such that air leaving the compression chamber passes through the wind turbine to enter the condensation chamber, the wind turbine acting as the restriction means.

4. A Gust Water Trap Apparatus according to claim 3, characterised in that the condensation chamber comprises means for feeding condensed water to a collection means and an exit for exhaust air.

5. A Gust Water Trap Apparatus according to claim 3, characterised in that the condensation chamber contains one or more baffles to increase the flow path of air therein.

6. A Gust Water Trap Apparatus according to claim 2, characterised in that the funnel has a flap leading into the compression chamber, which flap is arranged to open under high wind pressure and to close when the wind pressure falls.

7. A Gust Water Trap Apparatus according to claim 2, characterised in that the means for receiving air from ambient wind comprises a plurality of entrances facing in different directions.

8. A Gust Water Trap Apparatus according to claim 1, characterised in that a fan is provided for directing the air from the funnel into the compression chamber.

9. A Gust Water Trap Apparatus according to claim 1, characterised in that the apparatus is arranged to be mounted on a pole in a rotatable manner.

10. A Gust Water Trap Apparatus according to claim 1, characterised in that the apparatus comprises an outer wall formed with air inlet apertures, an inner wall spaced from the outer wall to form an entry chamber and ducts leading from the entry chamber into the compression chamber.

11. A Gust Water Trap Apparatus according to claim 4, characterised in that the condensation chamber contains one or more baffles to increase the flow path of air therein.

12. A Gust Water Trap Apparatus according to claim 11, characterised in that the funnel has a flap leading into the compression chamber, which flap is arranged to open under high wind pressure and to close when the wind pressure falls.

13. A Gust Water Trap Apparatus according to claim 12, characterised in that the means for receiving air from ambient wind comprises a plurality of entrances facing in different directions.

14. A Gust Water Trap Apparatus according to claim 13 characterised in that a fan is provided for directing the air from the funnel into the compression chamber.

15. A combination of:
a pole; and
a gust water trap apparatus according to claim 14 mounted on the pole in a rotatable manner.

16. A combination of:
a pole; and
a gust water trap apparatus according to claim 10 mounted on the pole in a rotatable manner.
